(19) United States
(12) Patent Application Publication
(10) Pub. No.: US 2026/0153818 A1
(43) Pub. Date: Jun. 4, 2026

(54) FIXING DEVICE AND IMAGE FORMING APPARATUS

(71) Applicant: CANON KABUSHIKI KAISHA, Tokyo (JP)

(72) Inventors: YASUHARU CHIYODA, Chiba (JP); YUSUKE YAMAGUCHI, Chiba (JP); TOSHINORI NAKAYAMA, Chiba (JP); DAIGO MATSUURA, Tokyo (JP); SHUTARO SAITO, Tokyo (JP); KOHEI AOKI, Chiba (JP); YUTARO OKADA, Chiba (JP)

(21) Appl. No.: 19/392,300

(22) Filed: Nov. 18, 2025

(30) Foreign Application Priority Data
Dec. 3, 2024 (JP) 2024-210080

(51) Int. Cl. G03G 15/20; G03G 15/00

(52) U.S. Cl. CPC G03G 15/2039; G03G 15/2053; G03G 15/2064; G03G 15/55; G03G 2215/2032

(57) ABSTRACT

A fixing device includes: a plurality of heating portions that heats an upper belt and a lower belt; a first temperature sensor disposed outside the upper belt, and configured to detect a temperature of the upper belt in a non-contact manner in a region where the upper belt ascends from an outlet of a nip portion; and a second temperature sensor configured to detect a temperature in a non-contact manner in a region other than the nip portion downstream of the first temperature sensor in a conveyance direction of the upper belt, in which an error is reported when a difference between the temperature detected by the first temperature sensor and the temperature detected by the second temperature sensor is equal to or more than a predetermined value.

### BACKGROUND

### Field of the Technology

The present disclosure relates to a heating type fixing device and an image forming apparatus including the fixing device.

### Description of the Related Art

Conventionally, there has been known an inkjet recording type image forming apparatus in which a recording medium to which ink has been applied is dried to evaporate moisture, and then heat and pressure are applied to the recording medium to fix an image. Conventionally, for such a fixing system that fixes an image by applying heat and pressure, a heat roller type has been adopted in which a recording medium passes between a heating roller and a pressure roller. In the conventional heat roller type fixing system, abnormal heating is detected using a thermistor brought into light contact with the heating roller, and power supply to a heater that heats the roller is cut off when the abnormal heating is detected.

In recent years, as image forming apparatuses have become faster and more productive, fixing systems have come into use, in which a pair of heating belts are used instead of rollers to increase the distance of the nip portion in the conveyance direction of the recording medium (for example, Japanese Patent Application Laid-Open No. 2018-136392). In such a fixing system, in order to quickly heat the recording medium that has entered the nip portion, an on-demand fixing type is used in which the belts are directly heated by heaters to shorten the warm-up time. In the on-demand fixing type, although thermal efficiency is high and the heating speed is fast, it is necessary to detect whether there is a temperature decrease after the recording medium passes and reheat the belts using the heaters when a temperature decrease is detected, and therefore, highly accurate temperature detection and control are required.

Conventionally, in the on-demand fixing type, it has been known that a temperature is detected using a contact-type sensor that is in contact with a belt. However, in a case where a temperature is detected using a contact-type sensor, there is a possibility that the sensor may be scraped as the sensor slides on the belt, and the scraped sensor may cause temperature unevenness and variations in contact pressure, resulting in a problem that the detected temperature is unstable.

On the other hand, conventionally, there has been known an on-demand fixing type in which a sensor that detects a temperature of a surface of a belt in a non-contact manner is provided outside the belt immediately downstream of a sheet discharging port. By using the non-contact type sensor, it is possible to prevent the sensor from being scraped by the belt.

### SUMMARY

A fixing device according to the present disclosure is a fixing device that heats and pressurizes a sheet to fix an image onto the sheet, the fixing device including: an endless upper belt; an endless lower belt configured to nip and convey the sheet together with the upper belt in a nip portion formed by abutting on the upper belt; a plurality of heating portions configured to heat the upper belt and the lower belt; a first temperature sensor disposed outside the upper belt, and configured to detect a temperature of the upper belt in a non-contact manner in a region where the upper belt ascends from an outlet of the nip portion; and a second temperature sensor configured to detect a temperature in a non-contact manner in a region other than the nip portion downstream of the first temperature sensor in a conveyance direction of the upper belt, in which an error is reported when a difference between the temperature detected by the first temperature sensor and the temperature detected by the second temperature sensor is equal to or more than a predetermined value.

Further features of the present disclosure will become apparent from the following description of exemplary embodiments with reference to the attached drawings.

### BRIEF DESCRIPTION OF THE DRAWINGS

FIG. 1 is a front schematic view of an image forming apparatus according to a first embodiment of the present disclosure;

FIG. 2 is a front cross-sectional view of a fixing module according to the first embodiment of the present disclosure;

FIG. 3 is a front cross-sectional view of a part of the fixing module according to the first embodiment of the present disclosure;

FIG. 4 is a schematic diagram of a part of a heating portion of the fixing module according to the first embodiment of the present disclosure;

FIG. 5 is a perspective view of a part of the fixing module according to the first embodiment of the present disclosure;

FIG. 6 is a side cross-sectional view of the fixing module according to the first embodiment of the present disclosure;

FIG. 7 is a block diagram illustrating a configuration of an upper fixing belt system of the fixing module according to the first embodiment of the present disclosure;

FIG. 8 is a block diagram illustrating a configuration of a lower fixing belt system of the fixing module according to the first embodiment of the present disclosure;

FIGS. 9A, 9B, and 9C are diagrams illustrating a configuration and characteristics of a heater of the fixing module according to the first embodiment of the present disclosure;

FIGS. 10A, 10B, and 10C are diagrams illustrating a schematic diagram and characteristics of a part of the fixing module according to the first embodiment of the present disclosure;

FIGS. 11A and 11B are diagrams illustrating a schematic diagram and characteristics of the heater of the fixing module according to the first embodiment of the present disclosure;

FIG. 12 is a flowchart illustrating an operation of the fixing module according to the first embodiment of the present disclosure;

FIG. 13 is a flowchart of an error detection process executed by the fixing module according to the first embodiment of the present disclosure;

FIG. 14 is a diagram illustrating arrangement positions of temperature sensors of the fixing module according to the first embodiment of the present disclosure; and

FIG. 15 is a flowchart of a temperature sensor selection process executed by a fixing module according to a second embodiment of the present disclosure.

### DESCRIPTION OF THE EMBODIMENTS

Hereinafter, embodiments will be described in detail with reference to the drawings.

### First Embodiment

### Configuration of Image Forming Apparatus

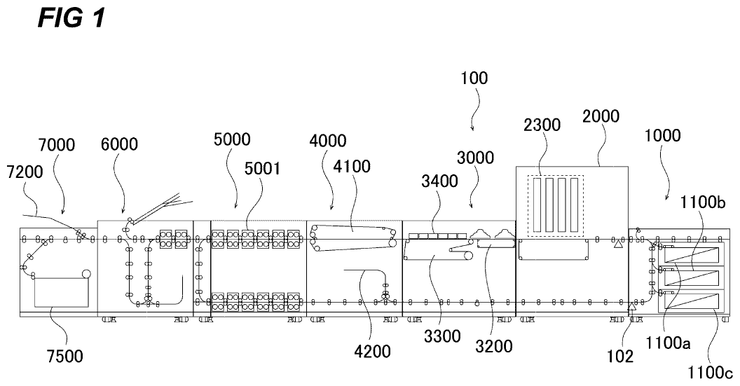

A configuration of an image forming apparatus 100 according to a first embodiment of the present disclosure will be described in detail with reference to FIG. 1. FIG. 1 is a front view of the image forming apparatus 100.

The image forming apparatus 100 uses an inkjet recording method in which ink is ejected to form an image on the sheet S, and is a so-called sheet-fed inkjet recording apparatus that forms an ink image on the sheet S using two liquids: a reaction liquid and ink. As the inkjet recording method, a method using a heat generating element, a method using a piezoelectric element, a method using an electrostatic element, a method using a micro electro mechanical systems (MEMS) element, or the like can be adopted.

Here, the sheet S is, for example, a recording material capable of receiving ink such as plain paper, thick paper, a specially shaped sheet, or cloth. The specially shaped sheet is a plastic film for an overhead projector, an envelope, index paper, or the like.

Specifically, the image forming apparatus 100 includes a feeding module 1000, a printing module 2000, a drying module 3000, a fixing module 4000, a cooling module 5000, an inverting module 6000, and a stacking module 7000.

The image forming apparatus 100 may be configured such that each of the feeding module 1000 to the stacking module 7000 has an individual housing, and the housings are connected to each other. Alternatively, in the image forming apparatus 100, the feeding module 1000, the printing module 2000, the drying module 3000, the fixing module 4000, the cooling module 5000, the inverting module 6000, and the stacking module 7000 may be disposed in one housing.

The feeding module 1000 accommodates sheets S. The feeding module 1000 separates the accommodated sheets S one by one using a separating belt (not illustrated), and feeds the sheets S to the printing module 2000 through a conveying roller (not illustrated). The feeding module 1000 includes a storage cabinet 1100a, a storage cabinet 1100b, and a storage cabinet 1100c. The number of storage cabinets 1100a, 1100b, and 1100c is not limited to three, and one, two, or four or more storage cabinets may be provided.

The storage cabinet 1100a stores sheets S, and is provided so as to be drawable from the front side of the image forming apparatus 100 in order to accommodate the sheets S.

The storage cabinet 1100b stores sheets S, and is provided so as to be drawable from the front side of the image forming apparatus 100 in order to accommodate the sheets S.

The storage cabinet 1100c stores sheets S, and is provided so as to be drawable from the front side of the image forming apparatus 100 in order to accommodate the sheets S.

The printing module 2000 serving as an image forming portion ejects ink onto the sheet S fed by the feeding module 1000 to form an image, and conveys the sheet S on which the image has been formed to the drying module 3000. The printing module 2000 includes a pre-image formation registration correction portion (not illustrated), a printing belt unit 2200, and a recording portion 2300.

The pre-image formation registration correction portion corrects the inclination and position of the sheet S fed by the feeding module 1000, and conveys the sheet S whose inclination and position have been corrected to the printing belt unit 2200.

The printing belt unit 2200 adsorbs and conveys the sheet S conveyed by the pre-image formation registration correction portion to ensure a clearance between the sheet S and a recording head.

The recording portion 2300 is disposed at a position facing the printing belt unit 2200 with respect to the conveyance path for the sheet S. The recording portion 2300 forms an image by ejecting ink onto the sheet S conveyed by the pre-image formation registration correction portion from above the recording head. A plurality of recording heads is arranged along the conveyance direction of the sheet S (hereinafter, simply referred to as the “conveyance direction”). Here, a total of five line-type recording heads are exemplified: four recording heads corresponding to yellow (Y), magenta (M), cyan (C), and black (Bk) plus a recording head corresponding to the reaction liquid. Note that the number of recording heads is not limited to five, and may be other than five.

The drying module 3000 serving as a drying portion blows hot air to the sheet S conveyed by the printing belt unit 2200 with the image formed thereon to dry the sheet S. The drying module 3000 dries the sheet S to reduce the liquid content of the ink and the reaction liquid applied to the sheet S in order to enhance the fixability of the ink to the sheet S in the subsequent fixing module 4000. The drying module 3000 conveys the dried sheet S to the fixing module 4000. The drying module 3000 includes a decoupling portion 3200, a drying belt unit 3300, and a hot air blowing unit 3400.

The decoupling portion 3200 generates a frictional force between the sheet S and the belt using the wind pressure of the wind blown from above, and conveys the sheet S placed on the belt to the drying belt unit 3300 through the belt. The decoupling portion 3200 prevents a misalignment of the sheet S when the sheet S is conveyed across the printing belt unit 2200 and the decoupling section 3200.

The drying belt unit 3300 adsorbs and conveys the sheet S conveyed by the decoupling portion 3200.

The hot air blowing unit 3400 includes a heater (not illustrated) that heats air, and is disposed above the belt. The hot air blowing unit 3400 heats air through the heater, and blows hot air, which is the heated air, to the sheet S adsorbed and conveyed by the drying belt unit 3300 to dry the ink and the reaction liquid applied to the sheet S. The heater is preferably, for example, an electric heating wire or an infrared heater from the viewpoint of safety and energy efficiency when the heater heats air. The drying method may be a combination of a method in which the surface of the sheet S is irradiated with electromagnetic waves such as ultraviolet rays or infrared rays or a conductive heat transfer method in which a heating element is brought into contact with the sheet S with the method in which hot air is blown.

The fixing module 4000 serving as a fixing device executes a fixing process of fixing the ink to the sheet S by heating the sheet S conveyed by the drying module 3000. The fixing module 4000 includes a fixing belt unit 4100 and an inverting portion 4200.

The fixing belt unit 4100 is provided in an upper portion of the fixing module 4000, and includes a substantially linear conveyance path for the sheet S. The fixing belt unit 4100 nips and conveys the sheet S conveyed by the drying module 3000 while heating and pressurizing the sheet S to fix the ink to the sheet S. The fixing belt unit 4100 conveys the sheet S to which the ink has been fixed to the cooling module 5000.

The inverting portion 4200 inverts the front and back sides of the sheet S conveyed by the cooling module 5000, and conveys the sheet S whose front and back sides have been inverted to the drying module 3000. Note that the configuration of the fixing module 4000 will be described in detail later.

The cooling module 5000 cools the high-temperature sheet S conveyed by the fixing module 4000, and conveys the cooled sheet S to a conveyance path to the inverting module 6000 or a duplex printing conveyance path for duplex printing in which images are formed on both sides. The cooling module 5000 includes a plurality of cooling portions 5001.

Each of the plurality of cooling portions 5001, for example, takes outside air into a cooling box using a fan to increase the pressure inside the cooling box, and blows air blown from the cooling box through a nozzle by the pressure toward the sheet S to cool the sheet S. The plurality of cooling portions 5001 is disposed on both sides of the conveyance path for the sheet S to cool both surfaces of the sheet S.

The inverting module 6000 inverts the front and back sides of the sheet S conveyed by the cooling module 5000 and conveys the sheet S to the stacking module 7000.

The stacking module 7000 stacks the sheet S conveyed by the inverting module 6000. The stacking module 7000 includes a top tray 7200 and a stacking portion 7500.

The top tray 7200 stacks the sheet S conveyed by the inverting module 6000.

The stacking portion 7500 stacks the sheet S conveyed by the inverting module 6000.

In the image forming apparatus 100 having the above-described configuration, the sheet S supplied from the feeding module 1000 undergoes various processes while being conveyed along the conveyance paths in the respective modules, and is finally discharged to the stacking module 7000.

Furthermore, the ink ejected onto the sheet S in the printing module 2000 contains 0.1 mass % to 20.0 mass % of a resin component with respect to the total mass of the ink, water, a water-soluble organic solvent, a coloring material, wax, and additives.

Further, when the sheet S on which an image has been formed in the recording portion 2300 is conveyed by the printing belt unit 2200, the sheet S is detected by an in-line scanner (not illustrated) disposed downstream of the recording portion 2300 in the conveyance direction. The in-line scanner detects a misalignment or a color density of the image formed on the sheet S. Based on the misalignment or color density of the image detected by the in-line scanner, the image forming apparatus 100 corrects the image, the density, or the like to be formed on the sheet S.

Furthermore, the drying module 3000 can suppress an occurrence of so-called cockling in which the sheet S absorbs the ink applied thereto and locally stretches, which causes wrinkles, by heating the ink and the reaction liquid applied to the sheet S to promote evaporation of moisture.

For duplex printing, the sheet S with an image formed by ink on one side thereof is conveyed to a conveyance path positioned below the cooling module 5000 by a conveyance path switching portion 5002. Thereafter, the sheet S is returned to the printing module 2000 through the duplex printing conveyance paths of the fixing module 4000, the drying module 3000, the printing module 2000, and the feeding module 1000. The sheet S returned to the printing module 2000 with no image formed on the other side thereof in the printing module 2000 is discharged, with an image formed on the other side thereof, from the drying module 3000 to the stacking module 7000 via the inverting module 6000.

### Configuration of Fixing Module

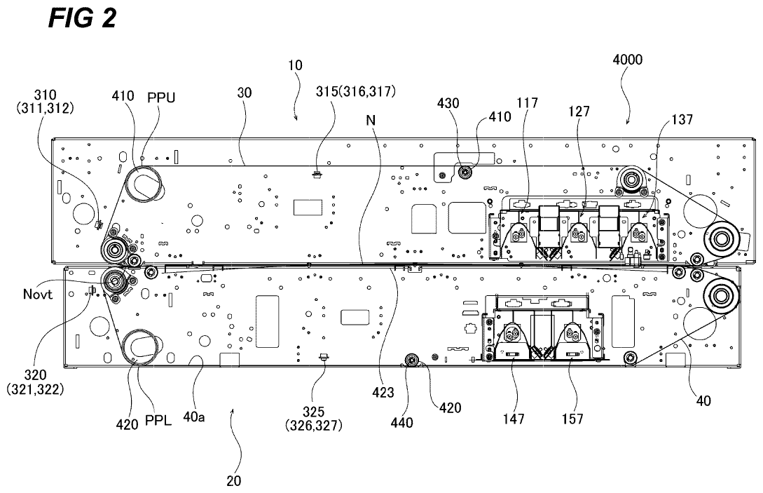

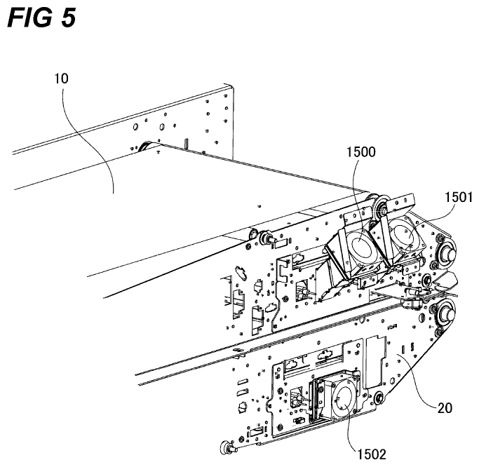

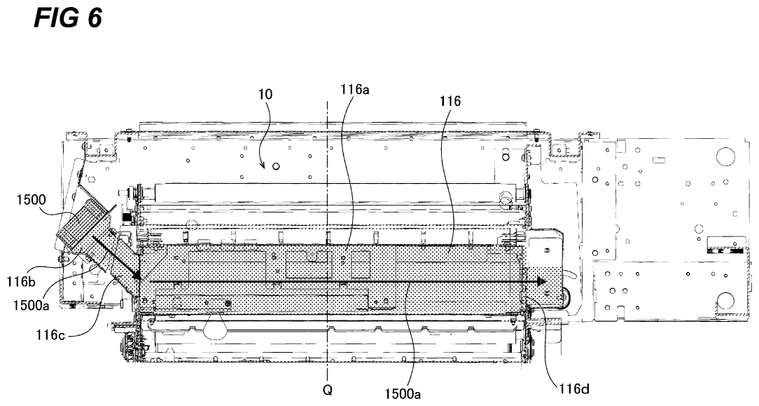

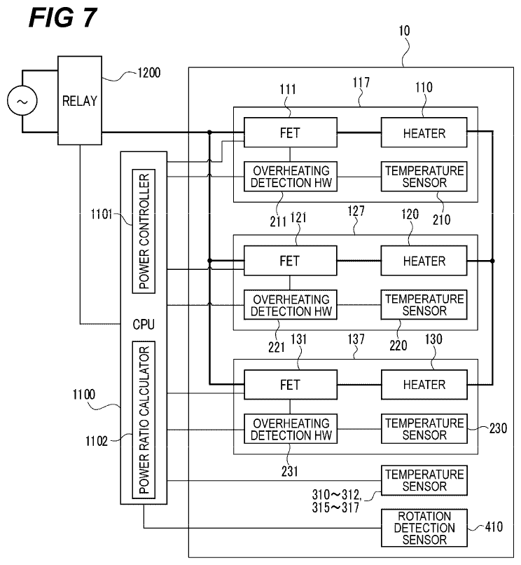

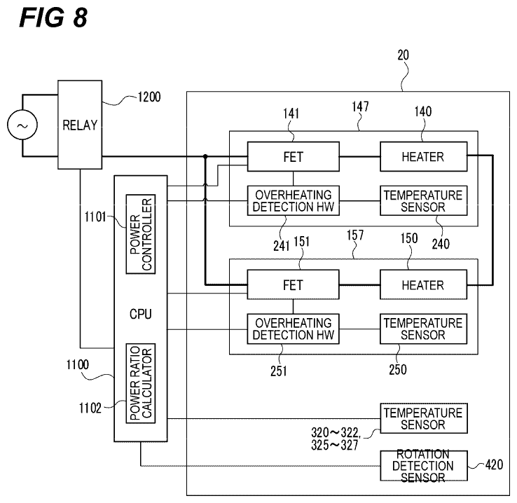

The configuration of the fixing module 4000 of the image forming apparatus 100 according to the first embodiment of the present disclosure will be described in detail with reference to FIGS. 2, 3, and 5 to 8.

The fixing module 4000 includes an upper fixing belt system 10, a lower fixing belt system 20, a CPU 1100, and a RELAY 1200.

The upper fixing belt system 10 is disposed above the lower fixing belt system 20 in the vertical direction (downward in FIG. 2). The upper fixing belt system 10 includes an upper belt 30, a heating portion 117, a heating portion 127, and a heating portion 137. In addition, the upper fixing belt system 10 includes a temperature sensor 310, a temperature sensor 311, a temperature sensor 312, a temperature sensor 315, a temperature sensor 316, a temperature sensor 317, a rotation detection sensor 410, a driven roller 430, and a driving roller 450.

Here, the temperature sensor 310, the temperature sensor 311, and the temperature sensor 312 are first temperature sensors, and the temperature sensor 315, the temperature sensor 316, and the temperature sensor 317 are second temperature sensors. In FIG. 2, the temperature sensor 311, the temperature sensor 312, the temperature sensor 316, and the temperature sensor 317 are not illustrated.

In order for the ink to permeate into the sheet S, moisture is required. Thus, the upper belt 30 is preferably made of a material that does not allow moisture to pass therethrough so that moisture evaporated from the surface of the sheet S does not escape through the upper belt 30 that comes into contact with the sheet S when the sheet S has a high temperature. In consideration of heat resistance, slidability, sealability, and durability, the upper belt 30 is exemplified here as being produced by coating a surface of a glass fiber substrate with polytetrafluoroethylene (PTFE). The thickness of the upper belt 30 is exemplified here as about 0.4 mm.

The upper belt 30 is endless, is stretched by a plurality of stretching rollers, and is detachably attachable. The upper belt 30 heats the sheet S conveyed by the drying module 3000 and conveys the heated sheet S to the cooling module 5000.

The heating portion 117, the heating portion 127, and the heating portion 137 are provided side by side along the conveyance direction above a nip portion N inside the upper belt 30. Each of the heating portion 117, the heating portion 127, and the heating portion 137 heats an inner surface of the upper belt 30 by heating the upper belt 30 from the inside. Note that the configurations of the heating portion 117, the heating portion 127, and the heating portion 137 will be described in detail later.

The temperature sensor 310 is a sensor used to detect a temperature of the upper belt 30 during temperature adjustment control, and to detect an error such as a tear of the upper belt 30. Each of the temperature sensor 311 and the temperature sensor 312 is a sensor used to detect an error such as a tear of the upper belt 30.

Each of the temperature sensor 310, the temperature sensor 311, and the temperature sensor 312 is provided outside the upper belt 30 and the lower belt 40. Each of the temperature sensor 310, the temperature sensor 311, and the temperature sensor 312 is provided in a region where the upper belt 30 ascends from an outlet Novt of the nip portion N. Each of the temperature sensor 310, the temperature sensor 311, and the temperature sensor 312 is provided between the outlet Novt of the nip portion N and a point PPU parallel to the nip portion N of the upper belt 30 in the rotation direction of the upper belt 30.

Each of the temperature sensor 310, the temperature sensor 311, and the temperature sensor 312 detects a surface temperature of the upper belt 30 in a non-contact manner, and outputs an electric signal corresponding to the detected surface temperature to the CPU 1100. Each of the temperature sensor 310, the temperature sensor 311, and the temperature sensor 312 is an infrared sensor that detects infrared rays. The temperature sensor 310, the temperature sensor 311, and the temperature sensor 312 are preferably disposed near the outlet Novt of the nip portion N in order to measure whether the sheet S passing through the nip portion N is fixably heated. However, in a case where the temperature sensor 310, the temperature sensor 311, and the temperature sensor 312 are disposed near the outlet Novt of the nip portion N, there is a possibility that the temperature sensor 310, the temperature sensor 311, and the temperature sensor 312 become contaminated by water vapor or paper dust, resulting in erroneous detection.

Each of the temperature sensor 315, the temperature sensor 316, and the temperature sensor 317 is a sensor used to detect an error such as a tear of the upper belt 30. Each of the temperature sensor 315, the temperature sensor 316, and the temperature sensor 317 is provided inside the upper belt 30. Each of the temperature sensor 315, the temperature sensor 316, and the temperature sensor 317 is provided in a region other than the nip portion N downstream of the temperature sensor 310, the temperature sensor 311, and the temperature sensor 312 in the conveyance direction of the upper belt 30. Note that each of the temperature sensor 315, the temperature sensor 316, and the temperature sensor 317 may be provided outside the upper belt 30 as long as it is not affected by paper dust and water vapor.

Each of the temperature sensor 315, the temperature sensor 316, and the temperature sensor 317 detects a surface temperature of the upper belt 30 in a non-contact manner, and outputs an electric signal corresponding to the detected surface temperature to the CPU 1100. Each of the temperature sensor 315, the temperature sensor 316, and the temperature sensor 317 is an infrared sensor that detects infrared rays.

The rotation detection sensor 410 is provided on a rotation shaft of the driven roller 430. The rotation detection sensor 410 is a Hall sensor including a magnet whose magnetic force is switched according to the rotation of the driven roller 430, and detects a rotation of the upper belt 30 and outputs an electric signal corresponding to the detected rotation of the upper belt 30 to the CPU 1100. Note that the rotation detection sensor 410 is not limited to the above-described configuration, and may be a transmission type sensor or the like that detects a light-shielding state or a light-transmitting state using a physical flag having an edge in the rotation direction of the driven roller 430.

The driven roller 430 is rotated following the rotation of the upper belt 30.

The driving roller 450 stretches the upper belt 30 together with the stretching rollers. The driving roller 450 is connected to a driving motor (not illustrated), and rotates when the driving motor is driven, causing the upper belt 30 to rotate due to a frictional force between the surface of the driving roller 450 and the inner surface of the upper belt 30.

The lower fixing belt system 20 is disposed below the upper fixing belt system 10 in the vertical direction. The lower fixing belt system 20 includes a lower belt 40, a heating portion 147, a heating portion 157, a temperature sensor 320, a temperature sensor 321, a temperature sensor 322, a temperature sensor 325, a temperature sensor 326, and a temperature sensor 327. In addition, the lower fixing belt system 20 includes a rotation detection sensor 420, a driven roller 440, a driving roller 460, a plurality of stretching rollers that stretches the lower belt 40, and a pad 423.

Here, the temperature sensor 320, the temperature sensor 321, and the temperature sensor 322 are first temperature sensors, and the temperature sensor 325, the temperature sensor 326, and the temperature sensor 327 are second temperature sensors. In FIG. 2, the temperature sensor 321, the temperature sensor 322, the temperature sensor 326, and the temperature sensor 327 are not illustrated.

In order for the ink to permeate into the sheet S, moisture is required. Thus, the lower belt 40 is preferably made of a material that does not allow moisture to pass therethrough so that moisture evaporated from the surface of the sheet S does not escape through the lower belt 40 that comes into contact with the sheet S when the sheet S has a high temperature. In consideration of heat resistance, slidability, sealability, and durability, the lower belt 40 is exemplified here as being made of a material obtained by coating a surface of a glass fiber substrate with polytetrafluoroethylene (PTFE) at a thickness of about 0.4 mm. The lower belt 40 is endless, and is stretched by a plurality of stretching rollers.

The lower belt 40 abuts on the upper belt 30 to form a nip portion N. The lower belt 40 nips and heats the sheet S conveyed by the drying module 3000 together with the upper belt 30 at the nip portion N, and conveys the sheet S to the cooling module 5000.

The heating portion 147 and the heating portion 157 are provided side by side inside the lower belt 40, and heat the lower belt 40 from the inside. Each of the heating portion 147 and the heating portion 157 heats a lower surface portion 40a of the lower belt 40 that is not in contact with the pad 423 extending in the horizontal direction from its inner surface. Note that the configurations of the heating portion 147 and the heating portion 157 will be described in detail later.

The temperature sensor 320 is a sensor used to detect a temperature of the lower belt 40 during temperature adjustment control, and to detect an error such as a tear of the lower belt 40. Each of the temperature sensor 321 and the temperature sensor 322 is a sensor used to detect an error such as a tear of the lower belt 40.

Each of the temperature sensor 320, the temperature sensor 321, and the temperature sensor 322 is provided outside the upper belt 30 and the lower belt 40. Each of the temperature sensor 320, the temperature sensor 321, and the temperature sensor 322 is provided in a region where the lower belt 40 descends from the outlet Novt of the nip portion N. Each of the temperature sensor 320, the temperature sensor 321, and the temperature sensor 322 is provided between the outlet Novt of the nip portion N and a point PPL parallel to the nip portion N of the lower belt 40 in the rotation direction of the lower belt 40.

Each of the temperature sensor 320, the temperature sensor 321, and the temperature sensor 322 detects a surface temperature of the lower belt 40 in a non-contact manner, and outputs an electric signal corresponding to the detected surface temperature to the CPU 1100. Each of the temperature sensor 320, the temperature sensor 321, and the temperature sensor 322 is an infrared sensor that detects infrared rays.

Each of the temperature sensor 325, the temperature sensor 326, and the temperature sensor 327 is a sensor used to detect an error such as a tear of the lower belt 40. Each of the temperature sensor 325, the temperature sensor 326, and the temperature sensor 327 is provided inside the lower belt 40. Each of the temperature sensor 325, the temperature sensor 326, and the temperature sensor 327 is provided in a region other than the nip portion N downstream of the temperature sensor 320, the temperature sensor 321, and the temperature sensor 322 in the conveyance direction of the lower belt 40. Each of the temperature sensor 325, the temperature sensor 326, and the temperature sensor 327 detects a surface temperature of the lower belt 40 in a non-contact manner, and outputs an electric signal corresponding to the detected surface temperature to the CPU 1100. Each of the temperature sensor 325, the temperature sensor 326, and the temperature sensor 327 is an infrared sensor that detects infrared rays.

The rotation detection sensor 420 is provided on a rotation shaft of the driven roller 440. The rotation detection sensor 420 is a Hall sensor including a magnet whose magnetic force is switched according to the rotation of the driven roller 440, and detects a rotation of the lower belt 40 and outputs an electric signal corresponding to the detected rotation of the lower belt 40 to the CPU 1100. Note that the rotation detection sensor 420 is not limited to the above-described configuration, and may be a transmission type sensor or the like that detects a light-shielding state or a light-transmitting state using a physical flag having an edge in the rotation direction of the driven roller 440.

The driven roller 440 is rotated following the rotation of the lower belt 40.

The driving roller 460 stretches the lower belt 40 together with the stretching rollers. The driving roller 460 is connected to a driving motor (not illustrated), and rotates when the driving motor is driven, causing the lower belt 40 to rotate due to a frictional force between the surface of the driving roller 460 and the inner surface of the lower belt 40.

The pad 423 is arranged to form a nip portion N with the upper belt 30 via the lower belt 40. Here, the pressure of the nip portion N is determined by the tension and thickness of the upper belt 30 and the curvature of the pad 423. If the pressure of the nip portion N is too high, there is a possibility that the ink on the sheet S may adhere to the upper fixing belt system 10 and the ink may be peeled off from the sheet S. Therefore, the pressure of the nip portion N is preferably 1 Pa to 2000 Pa, and more preferably 1 Pa to 200 Pa.

The radius of curvature of the pad 423 is desirably 50 mm or more, and is desirably 100,000 mm or less from the viewpoint of manufacturing accuracy. If the curvature of the pad 423 is large, the difference in the conveyance path between the front side and the back side of the sheet S increases, and there is a possibility that rubbing occurs between the sheet S and the belt. In addition, if the curvature of the pad 423 is large, there is a possibility that the sheet S may memorize the curved shape and curl.

From the above, the tension of the upper belt 30 is exemplified here as 200 N, the thickness of the upper belt 30 is exemplified here as 0.3 mm, the radius of curvature of the pad 423 is exemplified here as 30,000 mm, and the pressure of the nip is exemplified here as about 16 Pa.

The CPU 1100 serving as a controller controls the heating portion 117, the heating portion 127, and the heating portion 137 based on temperatures indicated by electric signals input from the temperature sensor 310, the temperature sensor 311, the temperature sensor 312, the temperature sensor 315, the temperature sensor 316, and the temperature sensor 317. The CPU 1100 performs temperature adjustment control for maintaining the temperature of the upper belt 30 at a predetermined temperature by controlling the heating portion 117, the heating portion 127, and the heating portion 137. Specifically, the CPU 1100 controls power supplied to the heating portion 117, the heating portion 127, and the heating portion 137 by controlling driving of the RELAY 1200, the FET 111, the FET 121, and the FET 131.

The CPU 1100 controls the heating portion 147 and the heating portion 157 based on temperatures indicated by electric signals input from the temperature sensor 320, the temperature sensor 321, the temperature sensor 322, the temperature sensor 325, the temperature sensor 326, and the temperature sensor 327. The CPU 1100 performs temperature adjustment control for maintaining the temperature of the lower belt 40 at a predetermined temperature by controlling the heating portion 147 and the heating portion 157. Specifically, the CPU 1100 controls power supplied to the heating portion 147 and the heating portion 157 by controlling driving of the RELAY 1200, the FET 141, and the FET 151.

The CPU 1100 reports an error when an abnormality is determined based on the electric signals input from the temperature sensor 310, the temperature sensor 311, the temperature sensor 312, the temperature sensor 315, the temperature sensor 316, and the temperature sensor 317.

The CPU 1100 reports an error when an abnormality is determined based on the electric signals input from the temperature sensor 320, the temperature sensor 321, the temperature sensor 322, the temperature sensor 325, the temperature sensor 326, and the temperature sensor 327. The CPU 1100 reports the error, for example, by displaying information indicating the abnormality on a display unit (not illustrated) or issuing a warning by voice or sound from a speaker (not illustrated).

The CPU 1100 stops driving the RELAY 1200 when it is detected that the upper belt 30 has stopped rotating based on an electric signal corresponding to the rotation of the upper belt 30 input from the rotation detection sensor 410. The CPU 1100 stops heating by the heating portion 117, the heating portion 127, and the heating portion 137 by stopping the driving of the RELAY 1200.

The CPU 1100 stops driving the RELAY 1200 when it is detected that the lower belt 40 has stopped rotating based on an electric signal corresponding to the rotation of the lower belt 40 input from the rotation detection sensor 420. The CPU 1100 stops heating by the heating portion 147 and the heating portion 157 by stopping the driving of the RELAY 1200.

The CPU 1100 includes a power controller 1101 and a power ratio calculator 1102.

The power controller 1101 controls power to be supplied to the heater 110, the heater 120, and the heater 130 by performing PWM control to achieve a power ratio calculated by the power ratio calculator 1102.

The power ratio calculator 1102 calculates a power ratio between the heater 110, the heater 120, and the heater 130 based on the electric signal corresponding to the detected temperature input from the temperature sensor 310.

The RELAY 1200 applies power to the heating portion 117, the heating portion 127, and the heating portion 137 under the control of the CPU 1100, or stops applying power to the heating portion 117, the heating portion 127, and the heating portion 137 under the control of the CPU 1100. The RELAY 1200 applies power to the heating portion 147 and the heating portion 157 under the control of the CPU 1100, or stops applying power to the heating portion 147 and the heating portion 157 under the control of the CPU 1100.

The fixing module 4000 having the above-described configuration includes a flow path portion 116a, which is a space serving as an air flow path surrounded by a reflector 116, a reflector 126, a reflector 115 of the heating portion 117 to be described later, and a reflector 125 of the heating portion 127 to be described later. In addition, the fixing module 4000 includes a flow path portion 126a, which is a space serving as an air flow path surrounded by a reflector 126, a reflector 136, a reflector 125 of the heating portion 127 to be described later, and a reflector 135 of the heating portion 137 to be described later.

Furthermore, the fixing module 4000 includes a flow path portion 146a, which is a space serving as an air flow path surrounded by a reflector 146, a reflector 156, a reflector 145 of the heating portion 147 to be described later, and a reflector 155 of the heating portion 157 to be described later.

### Configuration of Heating Portion

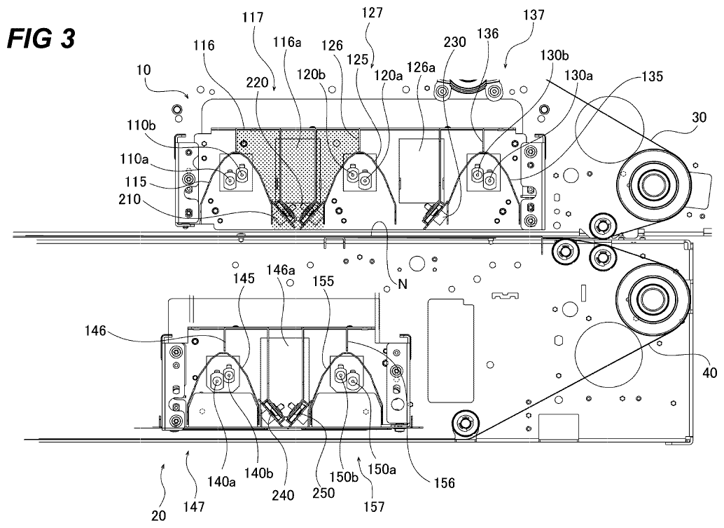

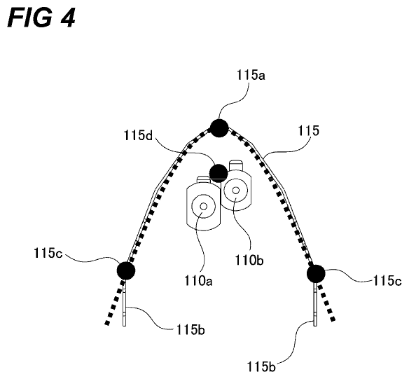

The configurations of the heating portion 117, the heating portion 127, the heating portion 137, the heating portion 147, and the heating portion 157 of the image forming apparatus 100 according to the first embodiment of the present disclosure will be described in detail with reference to FIGS. 3 and 4. Note that FIG. 3 is a front view of a part of the fixing module 4000.

The heating portion 117 includes a heater 110, an FET 111, a reflector 115, a temperature sensor 210, and an overheating detection HW 211.

The heater 110 is a halogen heater capable of supplying higher power. The heater 110 is supported by a support portion (not illustrated) provided in the apparatus body of the image forming apparatus 100. The heater 110 is disposed at a position closer to the upper belt 30 than a focal portion 115d of a parabola of the reflector 115 having a parabolic shape when viewed from the front, and heats the upper belt 30 immediately below in the vertical direction. The heater 110 is disposed so as not to interfere with a detection region 2101 of the temperature sensor 210.

The heater 110 includes two heaters 110a and 110b having different maximum powers. The heater 110a is disposed below the heater 110b. The heater 110b has a lower maximum power and a lower power than the heater 110a.

The FET 111 is turned on by the ON/OFF control of the CPU 1100 to supply power to the heater 110, and is turned off by the ON/OFF control of the CPU 1100 to stop the supply of power to the heater 110. The FET 111 is turned off by the overheating detection HW 211 to stop the supply of power to the heater 110.

The reflector 115 has a parabolic shape that is convex upward when viewed from the front from a vertex portion 115a to a parabola end portion 115c, and covers the heater 110. The reflector 115 uses, for example, a mirror-finished aluminum member or the like, and reflects light generated upward from the heater 110 downward to concentrate the light on the upper belt 30. The reflector 115 includes a straight portion 115b extending from the parabola end portion 115c toward the upper belt 30 in the vertical direction.

The straight portion 115b is provided to secure a space for arranging the temperature sensor 210. Preferably, the straight portion 115b is eliminated, or is formed as short as possible.

The temperature sensor 210 is a sensor for safety used to control the upper belt 30 so as not to have a temperature equal to or higher than a predetermined temperature. The predetermined temperature is a temperature set so that the upper belt 30 is not deformed by heat. Although the predetermined temperature is exemplified here as 200° C., it is not limited to 200° C. because it is a temperature determined depending on the material of the upper belt 30. The temperature sensor 210 is disposed between the reflector 115 and the reflector 125 of the heating portion 127 to be described later. The temperature sensor 210 detects a temperature of a region heated by the heater 110 of the upper belt 30 in a non-contact manner, and outputs an electric signal corresponding to the detected temperature to the overheating detection HW 211. The temperature sensor 210 is an infrared sensor that detects infrared rays.

The temperature sensor 210 is disposed in the vicinity of the reflector 115 outside the reflector 115 because it is necessary to directly detect the temperature of the region heated by the heater 110 of the upper belt 30. The temperature sensor 210 is provided in the vicinity of the heater 110b side of the reflector 115. At least a part of the temperature sensor 210 is disposed in the flow path portion 116a. The temperature sensor 210 is disposed outside the end of the upper belt 30 in a width direction (a direction orthogonal to the paper surface in FIG. 2) orthogonal to the conveyance direction (hereinafter, simply referred to as “width direction”).

The overheating detection HW 211 outputs the electric signal input from the temperature sensor 210 to the CPU 1100, and turns off the FET 111 in a hard manner according to the temperature indicated by the electric signal input from the temperature sensor 210.

The heating portion 127 includes a heater 120, an FET 121, a reflector 125, a temperature sensor 220, and an overheating detection HW 221. The configurations of the FET 121, the reflector 125, and the overheating detection HW 221 are the same as the configurations of the FET 111, the reflector 115, and the overheating detection HW 211, respectively, and thus the description thereof will be omitted.

The heater 120 includes two heaters 120a and 120b having different maximum powers. The heater 120a is disposed below the heater 120b. The heater 120b has a lower maximum power and a lower power than the heater 120a. The heater 120 is disposed so as not to interfere with a detection region of the temperature sensor 220. The configuration of the heater 120 other than the above-described configuration is the same as that of the heater 110, and thus the description thereof will be omitted.

The temperature sensor 220 is disposed between the reflector 115 and the reflector 125. The temperature sensor 220 detects a temperature of a region heated by the heater 120 of the upper belt 30 in a non-contact manner, and outputs an electric signal corresponding to the detected temperature to the overheating detection HW 221. The temperature sensor 220 is disposed in the vicinity of the reflector 125 outside the reflector 125 because it is necessary to directly detect the temperature of the region heated by the heater 120 of the upper belt 30.

The temperature sensor 220 is provided in the vicinity of the heater 120b side of the reflector 125. At least a part of the temperature sensor 220 is disposed in the flow path portion 116a. The configuration of the temperature sensor 220 other than the above-described configuration is the same as that of the temperature sensor 210, and thus the description thereof will be omitted.

The heating portion 137 includes a heater 130, an FET 131, a reflector 135, a temperature sensor 230, and an overheating detection HW 231. The configurations of the FET 131, the reflector 135, and the overheating detection HW 231 are the same as the configurations of the FET 111, the reflector 115, and the overheating detection HW 211, respectively, and thus the description thereof will be omitted.

The heater 130 includes two heaters 130a and 130b having different maximum powers. The heater 130a is disposed below the heater 130b. The heater 130b has a lower maximum power and a lower power than the heater 130a. The heater 130 is disposed so as not to interfere with a detection region of the temperature sensor 230. The configuration of the heater 130 other than the above-described configuration is the same as that of the heater 110, and thus the description thereof will be omitted.

The temperature sensor 230 is disposed between the reflector 125 and the reflector 135. The temperature sensor 230 detects a temperature of a region heated by the heater 130 of the upper belt 30 in a non-contact manner, and outputs an electric signal corresponding to the detected temperature to the overheating detection HW 231. The temperature sensor 230 is disposed in the vicinity of the reflector 135 outside the reflector 135 because it is necessary to directly detect the temperature of the region heated by the heater 130 of the upper belt 30.

The temperature sensor 230 is provided in the vicinity of the heater 130b side of the reflector 135. At least a part of the temperature sensor 230 is disposed in the flow path portion 126a. The configuration of the temperature sensor 230 other than the above-described configuration is the same as that of the temperature sensor 210, and thus the description thereof will be omitted.

The heating portion 147 includes a heater 140, an FET 141, a reflector 145, a temperature sensor 240, and an overheating detection HW 241. The configurations of the FET 141, the reflector 145, and the overheating detection HW 241 are the same as the configurations of the FET 111, the reflector 115, and the overheating detection HW 211, respectively, and thus the description thereof will be omitted.

The heater 140 includes two heaters 140a and 140b having different maximum powers. The heater 140a is disposed below the heater 140b. The heater 140b has a lower maximum power and a lower power than the heater 140a. The heater 140 is disposed so as not to interfere with a detection region of the temperature sensor 240. The configuration of the heater 140 other than the above-described configuration is the same as that of the heater 110, and thus the description thereof will be omitted.

The temperature sensor 240 is a sensor for safety used to control the lower belt 40 so as not to have a temperature equal to or higher than a predetermined temperature. The predetermined temperature is a temperature set so that the lower belt 40 is not deformed by heat. Although the predetermined temperature is exemplified here as 200° C., it is not limited to 200° C. because it is a temperature determined depending on the material of the lower belt 40. The temperature sensor 240 is disposed between the reflector 145 and the reflector 155 of the heating portion 157 to be described later. The temperature sensor 240 detects a temperature of a region heated by the heater 140 of the lower belt 40 in a non-contact manner, and outputs an electric signal corresponding to the detected temperature to the overheating detection HW 241. The temperature sensor 240 is an infrared sensor that detects infrared rays.

The temperature sensor 240 is disposed in the vicinity of the reflector 145 outside the reflector 145 because it is necessary to directly detect the temperature of the region heated by the heater 140 of the lower belt 40. The temperature sensor 240 is provided in the vicinity of the heater 140b side of the reflector 145. At least a part of the temperature sensor 240 is disposed in the flow path portion 146a. The temperature sensor 240 is disposed outside the end of the lower belt 40 in the width direction.

The heating portion 157 includes a heater 150, an FET 151, a reflector 155, a temperature sensor 250, and an overheating detection HW 251. The configurations of the FET 151, the reflector 155, and the overheating detection HW 251 are the same as the configurations of the FET 111, the reflector 115, and the overheating detection HW 211, respectively, and thus the description thereof will be omitted.

The heater 150 includes two heaters 150a and 150b having different maximum powers. The heater 150a is disposed below the heater 150b. The heater 150b has a lower maximum power and a lower power than the heater 150a. The heater 150 is disposed so as not to interfere with a detection region of the temperature sensor 250. The configuration of the heater 150 other than the above-described configuration is the same as that of the heater 110, and thus the description thereof will be omitted.

The temperature sensor 250 is disposed between the reflector 145 and the reflector 155. The temperature sensor 250 detects a temperature of a region heated by the heater 150 of the lower belt 40 in a non-contact manner, and outputs an electric signal corresponding to the detected temperature to the overheating detection HW 251. The temperature sensor 250 is disposed in the vicinity of the reflector 155 outside the reflector 155 because it is necessary to directly detect the temperature of the region heated by the heater 150 of the lower belt 40.

The temperature sensor 250 is provided in the vicinity of the heater 150b side of the reflector 155. At least a part of the temperature sensor 250 is disposed in the flow path portion 146a. The configuration of the temperature sensor 250 other than the above-described configuration is the same as the configuration of the temperature sensor 240, and thus the description thereof will be omitted.

In a case where the three heating portions 117, 127, and 137 are provided side by side, all the temperature sensors 210, 220, and 230 cannot be placed close to the heater 110b, the heater 120b, and the heater 130b on the low-power side. That is, the temperature sensor 230 is located closer to the heater 120a on the high-power side. However, in this case, at least the temperature sensor 210 and the temperature sensor 220 are disposed so as not to be as close as possible to the heater 120a and the heater 130a on the high-power side.

The reflector 115, the reflector 125, the reflector 135, the reflector 145, and the reflector 155 are formed in a parabolic shape that is convex upward when viewed from the front. However, each of the reflectors is not limited thereto, and may have a polygonal shape by connecting a plurality of members to approximate a parabolic shape that is convex upward when viewed from the front.

### Configuration of Temperature Sensor

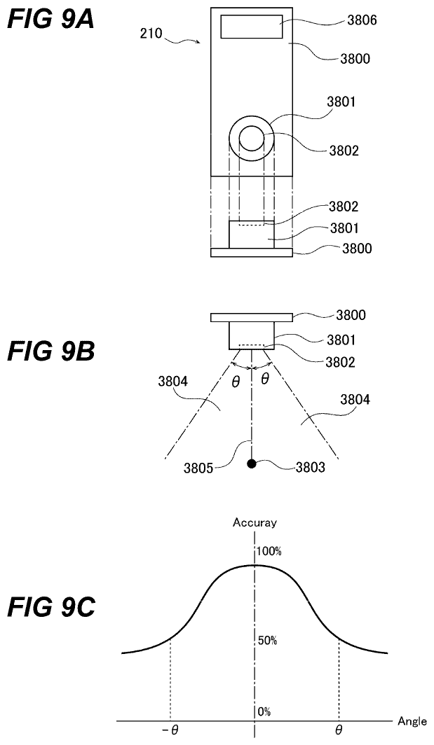

The configurations of the temperature sensors 210, 220, 230, 240, 250, 310, 311, 312, 315, 316, 317, 320, 321, 322, 325, 326, and 327 of the image forming apparatus 100 according to the present embodiment will be described in detail with reference to FIG. 9.

In FIG. 9, FIG. 9A is a view illustrating an outer shape of the temperature sensor 210, FIG. 9B illustrates a viewing angle θ of the temperature sensor 210, and FIG. 9C illustrates a relationship between the temperature measurement accuracy and the viewing angle θ of the temperature sensor 210.

The temperature sensors 210, 220, 230, 240, 250, 310, 311, 312, 315, 316, 317, 320, 321, 322, 325, 326, and 327 have the same configuration, and therefore, only the configuration of the temperature sensor 210 will be described.

The temperature sensor 210 includes a substrate 3800, a sensor module 3801, and a connector 3806.

The sensor module 3801 and the connector 3806 are mounted on the substrate 3800.

Among the components mounted on the substrate 3800, the sensor module 3801 is disposed closest to the end of substrate 3800. The sensor module 3801 includes a detection window 3802 serving as a lens. The sensor module 3801 absorbs infrared rays radiated from a measurement target 3803 through the detection window 3802, converts the absorbed infrared rays into an electric signal, and outputs the converted electric signal to the outside through the connector 3806.

The connector 3806 is mounted on the substrate 3800 and connected to a connection destination of the temperature sensor 210.

The temperature sensor 210 having the above-described configuration detects a temperature of the measurement target 3803 in a non-contact manner. Here, the temperature measurement accuracy in the state of FIG. 9B in which the measurement target 3803 is present on the center line 3805 is assumed to be 100%. Then, an angle formed by the measurement target 3803 and the center line 3805 when the temperature measurement accuracy decreases to 50% by moving the measurement target 3803 from the center line 3805 without changing the distance to the temperature sensor 210 is defined as a viewing angle θ. Note that the temperature measurement accuracy when setting the viewing angle θ is not limited to 50%, and may be any value.

### Configuration for Arrangement of Temperature Sensors

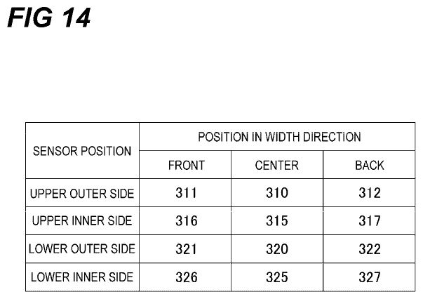

The configuration for the arrangement of the temperature sensors 310, 311, 312, 315, 316, 317, 320, 321, 322, 325, 326, and 327 of the image forming apparatus 100 according to the first embodiment of the present disclosure will be described in detail with reference to FIGS. 2 and 14.

In FIG. 14, “front” indicates one end side in the width direction of the fixing module 4000 (the front side in FIG. 2), and “back” indicates the other end side in the width direction of the fixing module 4000 (the back side in FIG. 2). The “center” indicates the center in the width direction of the fixing module 4000.

In FIG. 14, “upper” indicates the upper fixing belt system 10, “lower” indicates the lower fixing belt system 20, “outer side” indicates the outer side of the upper belt 30 and the outer side of the lower belt 40, and “inner side” indicates the inner side of the upper belt 30 or the inner side of the lower belt 40.

For example, “upper inner side” is located about 600 mm downstream of “upper outer side” in the conveyance direction, and “lower inner side” is located about 500 mm downstream of “lower outer side” in the conveyance direction. Further, when the “center” is assumed to be 0 mm, “front” is a position 160 mm in front of the “center”, and “back” is a position 160 mm behind the “center”.

The temperature sensor 310, the temperature sensor 311, and the temperature sensor 312 are arranged at intervals at the center, the front, and the back, respectively, in the width direction outside the upper belt 30. The temperature sensor 315, the temperature sensor 316, and the temperature sensor 317 are arranged at intervals at the center, the front, and the back, respectively, in the width direction inside the upper belt 30. The temperature sensor 320, the temperature sensor 321, and the temperature sensor 322 are arranged at intervals at the center, the front, and the back, respectively, in the width direction outside the lower belt 40. The temperature sensor 325, the temperature sensor 326, and the temperature sensor 327 are arranged at intervals at the center, the front, and the back, respectively, in the width direction inside the lower belt 40.

The temperature sensor 310, the temperature sensor 315, the temperature sensor 320, and the temperature sensor 325 are arranged at the same position (center) in a direction orthogonal to the conveyance direction. The temperature sensor 311, the temperature sensor 316, the temperature sensor 321, and the temperature sensor 326 are arranged at the same position (a position 160 mm in front of the center) in a direction orthogonal to the conveyance direction. The temperature sensor 312, the temperature sensor 317, the temperature sensor 322, and the temperature sensor 327 are arranged at the same position (a position 160 mm behind the center) in a direction orthogonal to the conveyance direction.

Note that the present embodiment is not limited to the above-described configuration for arrangement, and the temperature sensor 311, the temperature sensor 312, the temperature sensor 316, the temperature sensor 317, the temperature sensor 321, the temperature sensor 322, the temperature sensor 326, and the temperature sensor 327 may not be provided. That is, only the temperature sensor 310, the temperature sensor 315, the temperature sensor 320, and the temperature sensor 325 may be arranged.

### Measures to Suppress Temperature Rise of Temperature Sensor

The measures to suppress temperature rises of the temperature sensors 210, 220, 230, 240, 250, 315, 316, 317, 325, 326, and 327 of the image forming apparatus 100 according to the first embodiment of the present disclosure will be described in detail.

First, the measures to suppress temperature rises of the temperature sensor 210, the temperature sensor 220, the temperature sensor 230, the temperature sensor 240, and the temperature sensor 250 will be described in detail with reference to FIGS. 3 to 6.

The reflector 115 is subjected to mirror finishing or the like in order to improve reflection efficiency, but absorbs a part of light from the heater 110, causing a rise in temperature. The reflector 125, the reflector 135, the reflector 145, and the reflector 155 are also similar to the reflector 115.

As a result, the temperature of the reflector of the conventional fixing module finally rises to about 300° C. In addition, the temperature of the temperature sensor disposed near the conventional reflector may rise to about 200° C. because the ambient atmosphere is also heated by the reflector heated to a high temperature. The heat-resistant temperature of the temperature sensor is about 110° C., and if the temperature of the temperature sensor disposed near the reflector rises to about 200° C., the temperature sensor may not be able to accurately detect a temperature.

On the other hand, in the present embodiment, the following measures 1 to 3 are taken in order to suppress temperature rises of the temperature sensor 210, the temperature sensor 220, the temperature sensor 230, the temperature sensor 240, and the temperature sensor 250.

### Measure 1

The temperature sensor 210 is disposed such that the distance to the heater 110b is shorter than the distance to the heater 110a. As a result, a temperature rise of the temperature sensor 210 can be suppressed because smaller power is input to the heater 110b than to the heater 110a. Note that, since the temperature sensor 220, the temperature sensor 230, the temperature sensor 240, and the temperature sensor 250 are arranged in the same manner as the temperature sensor 210, temperature rises of the temperature sensor 220, the temperature sensor 230, the temperature sensor 240, and the temperature sensor 250 can be suppressed.

### Measure 2

Air flows from the fan 1500 into the flow path portion 116a outside the reflector 115 via a flow path inlet frame 116b and a flow path inlet unit 116c. In addition, a flow path outlet 116d for discharging the air flowing through the flow path portion 116a to the outside of the upper fixing belt system 10 is provided downstream of the air flow path of the flow path portion 116a. The fan 1500 sends the sucked air in a direction indicated by an arrow 1500a, thereby forming an air flow in the flow path portion 116a. Note that the reflector 116 may be made of a plurality of members, and a part of the reflector 115 of the adjacent heating portion 127 may also have the function of the reflector 116.

In addition, at least a part of the temperature sensor 210 is disposed in the flow path portion 116a. The temperature sensor 210 is disposed between the reflector 115 and the reflector 125, and is disposed at a position close to the fan 1500 with respect to the center Q in the width direction of the upper belt 30. As a result, the temperature sensor 210 is sufficiently cooled by the air flow formed in the flow path portion 116a.

Note that, since the temperature sensors 220, 230, 240, and 250 are arranged in the same manner as the temperature sensor 210, the temperature sensors 220, 230, 240, and 250 are sufficiently cooled by the air flow.

### Measure 3

In a case where the plurality of heating portions 147 and 157 are arranged side by side, the temperature sensor 240 provided in the heating portion 147 and the temperature sensor 250 provided in the heating portion 157 are arranged between the reflector 145 and the reflector 155. At this time, the temperature sensor 240 and the temperature sensor 250 are also heated by thermal energy supplied from the adjacent reflectors 145 and 155.

On the other hand, the temperature sensor 240 is disposed closer to the low-power heater 140b than to the heater 140a of the reflector 145, and the temperature sensor 250 is disposed closer to the low-power heater 150b than to the heater 150a of the reflector 155. As a result, temperature rises of the temperature sensor 240 and the temperature sensor 250 can be suppressed.

Note that, since the temperature sensor 210 and the temperature sensor 220 are arranged in the same manner as the temperature sensor 240 and the temperature sensor 250, temperature rises of the temperature sensor 210 and the temperature sensor 220 can be suppressed.

In addition, at least a part of the temperature sensor 240 and at least a part of the temperature sensor 250 are disposed in the flow path portion 146a. As a result, since the two temperature sensors 240 and 250 can be arranged in one flow path portion 146a, the temperature sensors 240 and 250 can be efficiently cooled by a small number of fans 1500.

Note that, since the temperature sensor 210 and the temperature sensor 220 are arranged in the same manner as the temperature sensor 240 and the temperature sensor 250, the temperature sensor 210 and the temperature sensor 220 can be efficiently cooled by a small number of fans 1500.

Next, the measures to suppress temperature rises of the temperature sensor 315, the temperature sensor 316, the temperature sensor 317, the temperature sensor 325, the temperature sensor 326, and the temperature sensor 327 will be described in detail with reference to FIG. 2.

The above-mentioned conventional problem that the detection accuracy decreases due to a change in emissivity caused by dew condensation on the IR sensor and contamination of the IR sensor due to paper dust or the like can be solved by providing non-contact IR sensors inside the upper belt and the lower belt. However, since the non-contact sensors are more susceptible to heat than contact sensors, in a case where the non-contact sensors are simply provided inside the upper belt and the lower belt, there is another problem that the detection accuracy decreases at a high temperature.

On the other hand, in the present embodiment, the temperature sensors 315, 316, and 317 disposed inside the upper belt 30 are located away from the heating portions 117, 127, and 137 and away from the regions heated by the heating portions 117, 127, and 137. In addition, the temperature sensor 325, the temperature sensor 326, and the temperature sensor 327 disposed inside the lower belt 40 are located away from the heating portion 147 and the heating portion 157 and away from the regions heated by the heating portion 147 and the heating portion 157.

Specifically, the temperature sensor 315, the temperature sensor 316, and the temperature sensor 317 are provided downstream of the nip portion N in the rotation direction of the upper belt 30, and are provided upstream of the heating portion 117, the heating portion 127, and the heating portion 137 in the rotation direction of the upper belt 30. In addition, the temperature sensor 325, the temperature sensor 326, and the temperature sensor 327 are provided downstream of the nip portion N in the rotation direction of the lower belt 40, and are provided upstream of the heating portion 117, the heating portion 127, and the heating portion 137 in the rotation direction of the lower belt 40.

As a result, it is possible to suppress temperature rises of the temperature sensor 315, the temperature sensor 316, and the temperature sensor 317 disposed inside the upper belt 30 and the temperature sensor 325, the temperature sensor 326, and the temperature sensor 327 disposed inside the lower belt 40.

### Operation of Fixing Module

The operation of the fixing module 4000 of the image forming apparatus 100 according to the first embodiment of the present disclosure will be described in detail with reference to FIGS. 2, 3, 7, and 8.

The sheet S is nipped and conveyed in the nip portion N formed by the upper belt 30 and the lower belt 40. By adopting such a configuration, even if the nip portion N is wide, the sheet S can be uniformly pressurized. As a result, even if the temperature of the upper fixing belt system 10 is set to the melting point of wax or the boiling point of water, heat can be sufficiently transferred to the sheet S by increasing the contact time between the sheet S and the upper belt 30.

On the other hand, if the sheet S is continuously nipped in the nip portion N after heat is sufficiently transferred to the sheet S, the ink on the sheet S may adhere to the upper belt 30 and the ink may be peeled off from the sheet S, or the upper belt 30 and the sheet S may be rubbed against each other, causing the image to become distorted. Therefore, since it is not preferable for the sheet S to be nipped in the nip portion N for too long, the time required from when the leading edge in the conveyance direction of the sheet S enters the nip portion N until it comes out of the nip portion N is desirably 0.5 sec to 4 sec.

The length of the pad 423 in the conveyance direction of the sheet S is exemplified here as 900 mm, and the speed at which the sheet S is conveyed is exemplified here as 700 mm/sec. The time required from when the leading edge in the conveyance direction of the sheet S enters the inlet of the nip portion N to when it comes out of the outlet of the nip portion N is exemplified here as about 1.3 sec.

By directly heating the nip portion N with the heating portion 117, the heating portion 127, and the heating portion 137 of the upper fixing belt system 10, heat can be efficiently transferred to the sheet S. On the other hand, the heating portion 147 and the heating portion 157 of the lower fixing belt system 20 cannot directly heat the nip portion N because the pad 423 is provided. In contrast, by arranging the heating portion 147 and the heating portion 157 so as to face the lower surface portion 40a of the lower belt 40, the lower belt 40 can be heated efficiently in a direct manner.

The CPU 1100 performs temperature adjustment control for maintaining the temperature of the upper belt 30 at a predetermined temperature by controlling the power supplied to the heater 110, the heater 120, and the heater 130 according to a value detected by the temperature sensor 310 that detects a surface temperature of the upper belt 30. The CPU 1100 performs temperature adjustment control for maintaining the temperature of the lower belt 40 at a predetermined temperature by controlling the power supplied to the heater 140 and the heater 150 according to a value detected by the temperature sensor 320 that detects a surface temperature of the lower belt 40.

When the rotation detection sensor 410 detects that the upper belt 30 has stopped rotating, the CPU 1100 controls the RELAY 1200 to stop the heating by the heating portion 117, the heating portion 127, and the heating portion 137. Similarly, when the rotation detection sensor 420 detects that the lower belt 40 has stopped rotating, the CPU 1100 controls the RELAY 1200 to stop the heating by the heating portion 147 and the heating portion 157. As a result, it is possible to prevent the upper belt 30 and the lower belt 40 from being heated in a state where their rotation is stopped, and it is possible to suppress the upper belt 30 and the lower belt 40 from being locally heated.

### Heating Operation of Heater

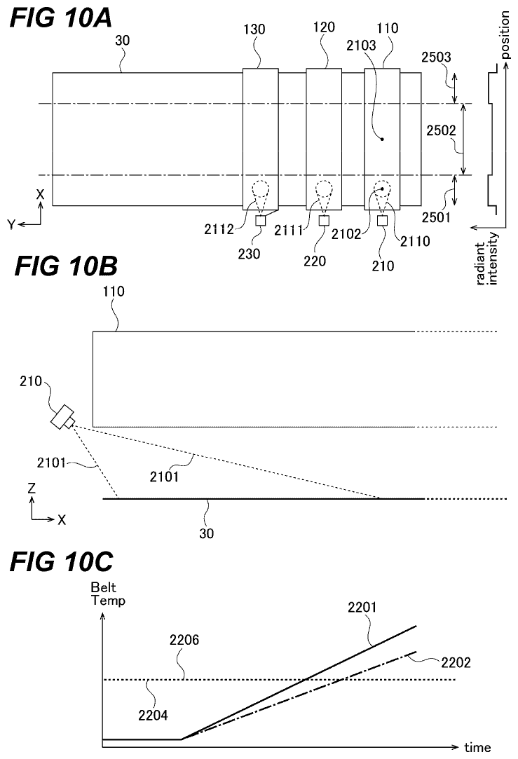

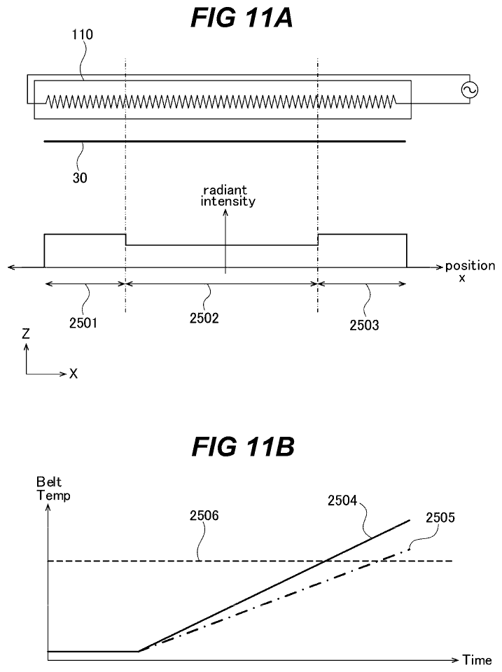

Heating operations of the heater 110, the heater 120, the heater 130, the heater 140, and the heater 150 of the image forming apparatus 100 according to the first embodiment of the present disclosure will be described in detail with reference to FIGS. 10 and 11.

In FIG. 10, FIG. 10A is a top view of the upper belt 30, the temperature sensor 210, the temperature sensor 220, and the temperature sensor 230. FIG. 10B illustrates a positional relationship between the upper belt 30, the heater 110, and the temperature sensor 210 when viewed from the upstream side in the conveyance direction. FIG. 10C illustrates a transition of temperature at each position of the upper belt 30 when the upper belt 30 is continuously heated by the heater 110.

In FIG. 11, FIG. 11A illustrates a positional relationship between the upper belt 30 and the heater 110 when viewed from the upstream side in the conveyance direction and a heating intensity at a position of the heater 110 in the width direction. FIG. 11B illustrates a transition of temperature of the upper belt 30 when the upper belt 30 is continuously heated by the heater 110.

The heating operations of the heaters 110, 120, 130, 140, and 150 are the same, only the heating operation of the heater 110 will be described, and the heating operations of the heaters 120, 130, 140, and 150 will not be described.

In FIGS. 10 and 11, the y-axis direction is the conveyance direction, the x-axis direction is the width direction, and the z-axis direction is the height direction.

FIG. 10C is a diagram illustrating a relationship between a heating time and a temperature of the upper belt 30 at each position on the upper belt 30 when the upper belt 30 is continuously heated by the heater 110, where the horizontal axis represents a time and the vertical axis represents a temperature of the upper belt 30. In FIG. 10C, a graph 2201 shows a transition of temperature at an end position 2102 immediately below the heater 110, and a graph 2202 shows a transition of temperature at a central position 2103 immediately below the heater 110.

The difference between the inclination of temperature rise in the graph 2201 and the inclination of temperature rise in the graph 2202 is a difference in light distribution of the heater 110. In addition, the temperature sensor 210 detects a temperature at the end position 2102, which is a region where the temperature rise rate is the highest. Therefore, a limit temperature 2206 of the upper belt 30 and an overheating detection threshold temperature 2204 are the same.

It has been described above that the limit temperature 2206 of the upper belt 30 and the overheating detection threshold temperature 2204 are set to the same temperature. However, the limit temperature 2206 of the upper belt 30 and the overheating detection threshold temperature 2204 are not limited thereto. For example, the overheating detection threshold temperature 2204 may have a safety margin, and the overheating detection threshold temperature 2204 may be set to a value lower than the limit temperature 2206 of the upper belt 30.

FIG. 11B is a diagram illustrating a relationship between a heating time and a temperature of the upper belt 30 when the upper belt 30 is continuously heated by the heater 110, where the horizontal axis represents a time and the vertical axis represents a temperature of the upper belt 30. A graph 2504 shows a temperature rise in an end region 2501 and an end region 2503, and a graph 2505 shows a temperature rise in a central region 2502. The heater 110 distributes light such that the heating intensity is higher in the end region 2501 and the end region 2503 than in the central region 2502. Therefore, the graph 2504 shows a temperature rise with a larger inclination than the graph 2505. As a result, it is possible to suppress uneven heating in the x-axis direction.

A limit temperature 2506 indicated by a broken line in FIG. 11B is a temperature set so that the upper belt 30 is not deformed, and is a temperature determined depending on the material of the upper belt 30. The overheating detection threshold temperature 2204 for detecting whether the upper belt 30 is overheated by the heating of the heater 110 needs to be set so that the upper belt 30 does not exceed the limit temperature 2506.

In addition, by arranging the heater 110 at a position closer to the upper belt 30 than to the focal portion 115d, a ratio of light reflected by the reflector 115 to light from the heater 110 can be reduced, making it possible to increase heating efficiency. When the heater 110 and the upper belt 30 are too close to each other, the efficiency in heating the upper belt 30 can be increased, but the intensity distribution of the light irradiated onto the upper belt 30 becomes more biased.

Furthermore, by arranging the two heaters 110a and 110b at different heights in the vertical direction, it is possible to make the way the light condensing distribution is biased different between the heaters 110a and 110b. As a result, when the two heaters 110a and 110b are simultaneously turned on, it is possible to suppress the light condensing distribution from being locally concentrated.

### Operation of Temperature Sensor

Operations of the temperature sensor 210, the temperature sensor 220, the temperature sensor 230, the temperature sensor 240, and the temperature sensor 250 of the image forming apparatus 100 according to the first embodiment of the present disclosure will be described in detail with reference to FIG. 10.

The temperature sensor 210 detects a temperature in a region 2110 of the upper belt 30 in FIG. 10A. The temperature sensor 220 detects a temperature in a region 2111 of the upper belt 30 in FIG. 10A. Furthermore, the temperature sensor 230 detects a temperature in a region 2112 of the upper belt 30 in FIG. 10A.

The operations of the temperature sensors 210, 220, 230, 240, and 250 are the same, only the operation of the temperature sensor 210 will be described, and the operations of the temperature sensors 220, 230, 240, and 250 will not be described.

The temperature sensor 210 disposed outside the upper belt 30 in the width direction obliquely detects a temperature in the end region 2501 at the end in the width direction of the upper belt 30. Therefore, the depression angle of the temperature sensor 210 with respect to the upper belt 30 becomes large. When the depression angle of the temperature sensor 210 is large, a wide region of the upper belt 30 is included in the detection region 2101 of the temperature sensor 210. On the other hand, a temperature sensor 210 having a narrow detection region 2101 is used, or a temperature sensor 210 having a wide detection region 2101 is used, and the overheating detection result detected by the temperature sensor 210 is corrected to have a margin.

When the upper belt 30 normally rotates to perform temperature adjustment control, the temperature sensor 210 normally continues to detect a temperature of about 130° C. or lower, and does not detect a temperature of 200° C. or higher. On the other hand, if the rotation detection sensor 420 fails and the upper belt 30 stops rotating, the area around the detection position of the temperature sensor 210 continues to be locally heated and becomes hot.

Even if the rotation detection sensor 420 fails and the upper belt 30 stops rotating as described above, the temperature sensor 210 can directly detect a temperature of the hottest area of the upper belt 30. As a result, the image forming apparatus 100 can be stopped before the upper belt 30 is damaged due to deformation or the like, making it possible to realize a safer fixing module 4000.

### Operation of Upper Fixing Belt System

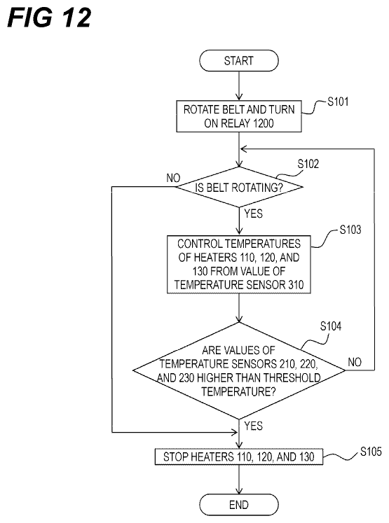

The operation of the upper fixing belt system 10 of the image forming apparatus 100 according to the first embodiment of the present disclosure will be described in detail with reference to FIG. 12.

The operation illustrated in FIG. 12 is started at a timing when the main power supply of the image forming apparatus 100 is turned on.

First, the CPU 1100 controls the driving of the driving motor (not illustrated) to rotate the upper belt 30, and turns on the RELAY 1200 (S101).

Next, the CPU 1100 determines whether the upper belt 30 is rotating based on an electric signal input from the rotation detection sensor 410 (S102).

When the upper belt 30 is rotating (step S102: Yes), the CPU 1100 controls the heater 110, the heater 120, and the heater 130 based on an electric signal corresponding to a temperature input from the temperature sensor 310 (S103). Specifically, the CPU 1100 controls the heater 110, the heater 120, and the heater 130 according to duty widths of PWM control signals output to the FET 111, the FET 121, and the FET 131. As a result, the CPU 1100 performs temperature adjustment control to maintain the upper belt 30 at a predetermined temperature.

Next, the CPU 1100 determines whether temperatures indicated by electric signals input from the temperature sensor 210, the temperature sensor 220, and the temperature sensor 230 are higher than a predetermined threshold temperature (S104). The threshold temperature is exemplified here as 200° C.

When the temperatures are higher than the threshold temperature (step S104: Yes), the CPU 1100 turns off the FET 111, the FET 121, and the FET 131 to stop the heater 110, the heater 120, and the heater 130 (S105). Then, the CPU 1100 ends the operation.

On the other hand, when the upper belt 30 is not rotating in the operation of step S102 (step S102: No), the CPU 1100 skips to the operation of step S105. As a result, it is possible to prevent the upper belt 30 from being locally heated by the heater 110, the heater 120, and the heater 130.

When the temperatures are equal to or lower than the threshold temperature in the operation of step S104 (step S104: No), the CPU 1100 returns to the operation of step S102.

Note that the operation of the lower fixing belt system 20 is the same as the operation illustrated in FIG. 12, and thus, the detailed description thereof will be omitted. At this time, the CPU 1100 controls the heater 140 and the heater 150 based on an electric signal corresponding to a temperature input from the temperature sensor 320. When the temperature detected by the temperature sensor 240 or the temperature sensor 250 is higher than the threshold temperature or when the rotation detection sensor 420 determines that the lower belt 40 is not rotating, the CPU 1100 stops the heater 140 and the heater 150.

### Error Detection Process

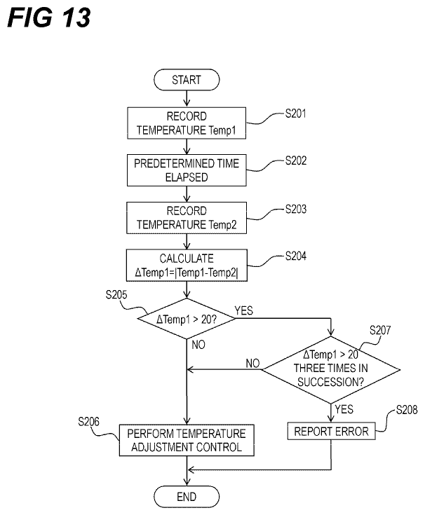

An error detection process executed by the image forming apparatus 100 according to the first embodiment of the present disclosure will be described in detail with reference to FIG. 13.

The error detection process illustrated in FIG. 13 is started at a timing when a temperature detected by the temperature sensor 310 and the temperature sensor 320 rises to a temperature at which printing is possible and enters a standby state. At this time, the fixing module 4000 conveys the sheet S at a conveyance speed of 700 mm/sec.

The error detection process illustrated in FIG. 13 is repeatedly executed at every predetermined control cycle. The control cycle is exemplified here as 100 msec.

First, the CPU 1100 records a temperature Temp1 indicated by an electric signal input from the temperature sensor 310 in a memory (not illustrated) (S201).

Next, the CPU 1100 acquires a temperature Temp2 indicated by an electric signal input from the temperature sensor 315 when a predetermined time has elapsed from the execution of the processing of step S201 (S202). The predetermined time is exemplified here as 0.86 seconds.

The predetermined time is obtained by dividing the distance between the temperature sensor 310 and the temperature sensor 315 by the conveyance speed. The temperature sensor 315 can detect a temperature at a position that is the same as the position of the upper belt 30 at which the temperature sensor 310 detected the temperature in the processing of step S201, by detecting the temperature after a predetermined time elapses from the execution of the processing of step S201.

Next, the CPU 1100 records the temperature Temp2 acquired in the processing of step S202 in the memory (S203).

Next, the CPU 1100 obtains an absolute value ΔTemp1 of a detected temperature difference that is a difference between the temperature Temp1 and the temperature Temp2 (ΔTemp1=|Temp1−Temp2|) (S204). In this manner, the CPU 1100 obtains the absolute value of the difference between the temperatures detected by the temperature sensors 310 and 315, respectively, which are provided at the same position in the width direction.

Next, the CPU 1100 determines whether the absolute value ΔTemp1 obtained in the processing of step S204 is larger than a predetermined value of 20° C. (S205).

When the absolute value ΔTemp1 is 20° C. or less (step S205: No), the CPU 1100 performs normal temperature adjustment control using the temperature sensor 310 (S206), and then ends the error detection process.

On the other hand, when the absolute value ΔTemp1 is larger than 20° C. (step S205: Yes), the CPU 1100 increments the count value counted by a counter (not illustrated). Then, referring to the count value, the CPU 1100 determines whether the absolute value ΔTemp1 is larger than 20° C. three times in succession in each control cycle (S207).

When the count value is equal to or less than 2 and the absolute value ΔTemp1 is not larger than 20° C. three times in succession (step S207: No), the CPU 1100 ends the error detection process.

On the other hand, when the count value is 3 and the absolute value ΔTemp1 is larger than 20° C. three times in succession (step S207: Yes), the CPU 1100 determines that the lower one of the detected temperatures Temp1 and Temp2 as a result of detection is abnormal. Then, the CPU 1100 reports error information (S207), then sets the count value of the counter (not illustrated) to “0”, and ends the error detection process. Here, the detected temperature Temp1 may be lower than the actual temperature of the upper belt 30 due to noise such as paper dust or water vapor emitted from the outlet of the nip portion N. In this case, erroneous detection occurs. However, by reporting error information when the absolute value ΔTemp1 is larger than 20° C. three times in succession, it is possible to suppress erroneous report of error information caused by erroneous detection due to noise.

The error information is reported by reporting information urging cleaning or replacement or issuing a warning. In addition, the error may be caused by a tear or drive failure of the upper belt 30.

In this manner, by executing the above-described error detection process described above, when temperature adjustment control is performed using the temperature sensor 310, it is possible to check whether the detection result of the temperature sensor 310 is normal or abnormal using the temperature sensor 315. When the detection result of the temperature sensor 310 is abnormal, the temperature adjustment control is stopped and the upper belt 30 is replaced, whereby the cause of the abnormal detection result of the temperature sensor 310 can be eliminated. Note that the threshold temperature for determining whether to report error information is not limited to 20° C., and a predetermined temperature other than 20° C. can be set in consideration of the temperature unevenness of the upper belt 30 or the lower belt 40, the variation in detection accuracy, or the like.

In addition to the above-described processes, the CPU 1100 executes the error detection process illustrated in FIG. 13 using the temperature sensor 320 and the temperature sensor 325. Note that the error detection process using the temperature sensor 320 and the temperature sensor 325 is the same as the above-described process except that the temperature sensor 320 is used instead of the temperature sensor 310 and the temperature sensor 325 is used instead of the temperature sensor 315, and thus the description thereof will be omitted. As a result, when temperature adjustment control is performed using the temperature sensor 320, it is possible to check whether the detection result of the temperature sensor 320 is normal or abnormal using the temperature sensor 325.

When executing the above-described error detection process using the temperature sensor 320 and the temperature sensor 325, the CPU 1100 acquires a temperature Temp2 detected by the temperature sensor 325 when a predetermined time has elapsed from the execution of the processing of step S201 (S202). The predetermined time is exemplified here as 0.71 seconds.

The predetermined time is obtained by dividing the distance between the temperature sensor 320 and the temperature sensor 325 by the conveyance speed. The temperature sensor 325 can detect a temperature at a position that is the same as the position of the lower belt 40 at which the temperature sensor 320 detected the temperature in the processing of step S201, by detecting the temperature after a predetermined time elapses from the execution of the processing of step S201.

In addition, the CPU 1100 executes the error detection process illustrated in FIG. 13 using the temperature sensor 311 and the temperature sensor 316. Note that the error detection process using the temperature sensor 311 and the temperature sensor 316 is the same processing as the above-described process except that the temperature sensor 311 is used instead of the temperature sensor 310 and the temperature sensor 316 is used instead of the temperature sensor 315, and thus the description thereof will be omitted. As a result, a tear or the like of the upper belt 30 can be detected using the temperature sensor 311 and the temperature sensor 316.

The CPU 1100 also executes the error detection process illustrated in FIG. 13 for the temperature sensor 312 and the temperature sensor 317. Note that the error detection process for the temperature sensor 312 and the temperature sensor 317 is the same as the above-described process except that the temperature sensor 312 is used instead of the temperature sensor 310 and the temperature sensor 317 is used instead of the temperature sensor 315, and thus the description thereof will be omitted. As a result, a tear or the like of the upper belt 30 can be detected using the temperature sensor 312 and the temperature sensor 317.

The CPU 1100 also executes the error detection process illustrated in FIG. 13 for the temperature sensor 321 and the temperature sensor 326. Note that the error detection process for the temperature sensor 321 and the temperature sensor 326 is the same as the above-described process except that the temperature sensor 321 is used instead of the temperature sensor 310 and the temperature sensor 326 is used instead of the temperature sensor 315, and thus the description thereof will be omitted. Thus, a tear or the like of the lower belt 40 can be detected using the temperature sensor 321 and the temperature sensor 326.

The CPU 1100 also executes the error detection process illustrated in FIG. 13 for the temperature sensor 322 and the temperature sensor 327. Note that the error detection process for the temperature sensor 322 and the temperature sensor 327 is the same as the above-described process except that the temperature sensor 322 is used instead of the temperature sensor 310 and the temperature sensor 327 is used instead of the temperature sensor 315, and thus the description thereof will be omitted. Thus, a tear or the like of the lower belt 40 can be detected using the temperature sensor 322 and the temperature sensor 327.

By executing the above-described error detection process, it is possible to accurately detect temperature changes of the upper belt 30 and the lower belt 40 in an on-demand manner in which the upper belt 30 and the lower belt 40 are directly heated. In addition, it is possible to grasp a degree of temperature unevenness detected by the temperature sensor 310 and the temperature sensor 320, and it is possible to easily detect an occurrence of an abnormality. Furthermore, detection errors of the temperature sensor 310 and the temperature sensor 320 can be corrected by referring to temperatures detected by the temperature sensors 311, 312, 315, 316, 317, 321, 322, 325, 326, and 327. As a result, temperature adjustment control can be performed more accurately than the conventional temperature adjustment control.

In the present embodiment, there are provided the temperature sensor 315, the temperature sensor 316, and the temperature sensor 317 disposed inside the upper belt 30 to detect a temperature of the upper belt 30 in a non-contact manner. Also, there are provided the CPU 1100 that performs temperature adjustment control for maintaining the temperature of the upper belt 30 at a predetermined temperature by controlling the plurality of heating portions 117, 127, and 137 based on the temperatures detected by the temperature sensor 310 and the temperature sensor 315.

Furthermore, the CPU 1100 performs temperature adjustment control for maintaining the temperature of the lower belt 40 at a predetermined temperature by controlling the plurality of heating portions 147 and 157 based on the temperatures detected by the temperature sensor 320 and the temperature sensor 325. As a result, when the upper belt 30 and the lower belt 40 are directly heated and maintained at a predetermined temperature, temperature changes of the upper belt 30 and the lower belt 40 can be accurately detected.

### Second Embodiment

The configurations of the image forming apparatus and the fixing module according to the second embodiment of the present disclosure are the same as those illustrated in FIGS. 1 to 3 and FIGS. 5 to 8, and thus the description thereof will be omitted. In addition, the configurations of the heating portions of the fixing module, the configurations of the temperature sensors, and the configuration for arrangement of the temperature sensors according to the present embodiment are the same as those illustrated in FIGS. 2 to 4, 9, and 14, and thus the description thereof will be omitted. Furthermore, measures to suppress temperature rises of the temperature sensors of the fixing module according to the present embodiment are the same as the measures to suppress temperature rises of the temperature sensors according to the first embodiment described above, and thus the description thereof will be omitted.

### Temperature Sensor Selection Process

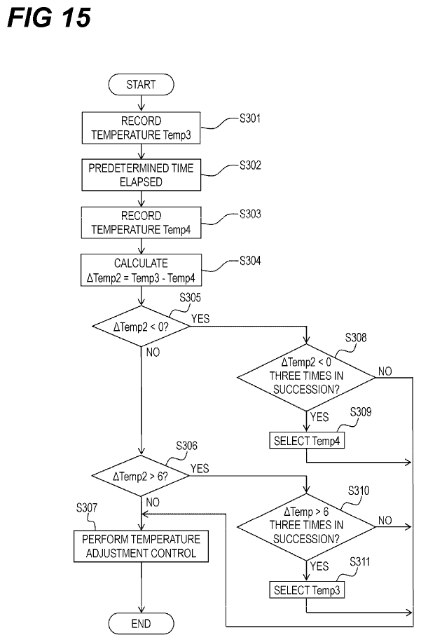

A temperature sensor selection process executed by the image forming apparatus 100 according to the second embodiment of the present disclosure will be described in detail with reference to FIG. 15.

In the first embodiment described above, the temperature sensor 315 is used to determine whether the temperature sensor 310 is abnormal or normal, and the temperature sensor 325 is used to determine whether the temperature sensor 320 is abnormal or normal. In the present embodiment, the temperature sensor 315 and the temperature sensor 325 are used for temperature adjustment control.

The temperature sensor selection process illustrated in FIG. 15 is started at a timing when a temperature detected by the temperature sensor 310 and the temperature sensor 320 rises to a temperature at which printing is possible and enters a standby state. At this time, the fixing module 4000 conveys the sheet S at a conveyance speed of 700 mm/sec.

First, the CPU 1100 records a temperature Temp3 obtained by adding the temperature detected by the temperature sensor 310 and the temperature detected by the temperature sensor 320 in a memory (not illustrated) (S301).

Next, the CPU 1100 acquires a temperature detected by the temperature sensor 315 when 0.86 seconds have elapsed from the execution of the processing of step S301 and a temperature detected by the temperature sensor 325 when 0.71 seconds have elapsed from the execution of the processing of step S301 (S302).

The temperature sensor 315 can detect a temperature at a position that is the same as the position of the upper belt 30 at which the temperature sensor 310 detected the temperature in the processing of step S301, by detecting the temperature after 0.86 seconds elapse from the execution of the processing of step S301. In addition, the temperature sensor 325 can detect a temperature at a position that is the same as the position of the lower belt 40 at which the temperature sensor 320 detected the temperature in the processing of step S301, by detecting the temperature after 0.71 seconds elapse from the execution of the processing of step S301.

Next, the CPU 1100 records, in the memory, a temperature Temp4 obtained by adding the temperature detected by the temperature sensor 320, which was acquired in the processing of step S302, and the temperature detected by the temperature sensor 325, which was acquired in the processing of step S302 (S303).

Next, the CPU 1100 obtains a detected temperature difference ΔTemp2, which is a difference between the temperature Temp3 and the temperature Temp4 (ΔTemp2=Temp3−Temp4) (S304).

Next, the CPU 1100 determines whether the detected temperature difference ΔTemp2 is smaller than “0” (S305).

When the detected temperature difference ΔTemp2 is equal to or larger than “0” (step S305: No), the CPU 1100 determines whether the detected temperature difference ΔTemp2 is larger than 6 (S306).

When the detected temperature difference ΔTemp2 is equal to or smaller than 6 (step S306: No), the CPU 1100 performs normal temperature adjustment control using the temperature sensor 310 or the temperature sensor 315 selected in the previous time by executing the temperature sensor selection process (S307). Thereafter, the CPU 1100 ends the temperature sensor selection process.

On the other hand, in the processing of step S305, when the detected temperature difference ΔTemp2 is smaller than “0” (step S305: Yes), the CPU 1100 increments a first count value of a counter (not illustrated). Then, referring to the first count value, the CPU 1100 determines whether the detected temperature difference ΔTemp2 is smaller than “0” three times in succession in each control cycle (S308).

When the first count value is equal to or less than 2 and the detected temperature difference ΔTemp2 is not smaller than “0” three times in succession (step S308: No), the CPU 1100 proceeds to the processing of step S307.

On the other hand, when the first count value is 3 and the detected temperature difference ΔTemp2 is smaller than “0” three times in succession (step S308: Yes), the CPU 1100 selects the value of the temperature Temp4 detected by the temperature sensor 315 and the temperature sensor 325 (S309). Thereafter, the CPU 1100 sets the first count value to “0”, and then proceeds to the processing of step S307.

At this time, the CPU 1100 performs temperature adjustment control using the temperature sensor 315 and the temperature sensor 325 selected in the processing of step S309. By selecting the temperature sensor 315 and the temperature sensor 325 when the detected temperature difference ΔTemp2 is smaller than “0” three times in succession, it is possible to reduce the possibility of erroneously selecting the temperature sensor 315 and the temperature sensor 325 due to the influence of detection noise.

In addition, in the processing of step S306, when the detected temperature difference ΔTemp2 is larger than 6 (step S306: Yes), the CPU 1100 increments a second count value. Then, referring to the second count value, the CPU 1100 determines whether the detected temperature difference ΔTemp2 is larger than 6 three times in succession in each control cycle (S310).

When the second count value is equal to or less than 2 and the detected temperature difference ΔTemp2 is not larger than 6 three times in succession (step S310: No), the CPU 1100 proceeds to the processing of step S307.

On the other hand, when the second count value is 3 and the detected temperature difference ΔTemp2 is larger than 6 three times in succession (step S310: Yes), the CPU 1100 selects the temperature Temp3 detected by the temperature sensor 310 and the temperature sensor 320 (S311). Thereafter, the CPU 1100 sets the second count value to “0”, and then proceeds to the processing of step S307.

At this time, the CPU 1100 performs temperature adjustment control using the temperature sensor 310 and the temperature sensor 320 selected in the processing of step S311. By selecting the temperature sensor 310 and the temperature sensor 320 when the detected temperature difference ΔTemp2 is larger than 6 three times in succession, it is possible to reduce the possibility of erroneously selecting the temperature sensor 310 and the temperature sensor 320 due to erroneous detection caused by noise.

In this manner, since the temperature adjustment control is performed using the temperature sensor 315 disposed inside the upper belt 30, a temperature of the upper belt 30 can be stably detected without being affected by changes in the shape and the surface property of the upper belt 30 with dirt adhering onto the upper belt 30. In addition, since the temperature adjustment control is performed using the temperature sensor 325 disposed inside the lower belt 40, a temperature of the lower belt 40 can be stably detected without being affected by changes in the shape and the surface property of the lower belt 40 with dirt adhering onto the lower belt 40.

In the above-described temperature sensor selection process, the temperature at the position detected by the temperature sensor 310 of the upper belt 30 decreases by about 3° C. until it reaches the temperature sensor 315 located downstream of the temperature sensor 310 in the rotation direction of the upper belt 30. Similarly, the temperature at the position detected by the temperature sensor 320 of the lower belt 40 decreases by about 3° C. until it reaches the temperature sensor 325 located downstream of the temperature sensor 320 in the rotation direction of the lower belt 40. Therefore, when the temperature sensor 310 is normal, the temperature sensor 315 detects a temperature that is 3° C. lower than the temperature detected by the temperature sensor 310. In addition, when the temperature sensor 320 is normal, the temperature sensor 325 detects a temperature that is 3° C. lower than the temperature detected by the temperature sensor 320.

As a result, the CPU 1100 selects the temperature sensor 310 and the temperature sensor 320 that have detected a higher temperature or the temperature sensor 315 and the temperature sensor 325 that have detected a higher temperature as normal temperature sensors. Specifically, when the detected temperature difference ΔTemp2 is lower than 0° C., the temperature detected by the temperature sensor 315 and the temperature sensor 325 is used for temperature adjustment control. When the detected temperature difference ΔTemp2 is larger than 6° C., the temperature detected by the temperature sensor 310 and the temperature sensor 320 is used for temperature adjustment control. When the detected temperature difference ΔTemp2 is equal to or more than 0° C. and equal to or less than 6° C., it is determined that the temperature sensors used for temperature adjustment control are normal, and the temperature adjustment control is performed using the temperature sensors selected in the previous time.

In addition, the temperature of the upper belt 30 varies in the width direction between a sheet passing area where the heat of the upper belt 30 is transferred to the sheet S as the sheet S passes therethrough and a non-sheet passing area where the heat of the upper belt 30 is not transferred to the sheet S as the sheet S does not pass therethrough. The same applies to the lower belt 40. As a result, the temperature difference described above causes heat energy unevenness on the surfaces of the upper belt 30 and the lower belt 40, and the heat energy unevenness causes temperature transfer between the sheet passing area and the non-sheet passing area as it moves downstream in the rotation direction of the upper belt 30 and the lower belt 40.

Therefore, normally, in order to suppress the influence of the temperature transfer, it is preferable to perform temperature adjustment control using the temperature sensor 310 disposed upstream of the temperature sensor 315 in the rotation direction of the upper belt 30. Similarly, normally, in order to suppress the influence of the temperature transfer, it is preferable to perform temperature adjustment control using the temperature sensor 320 disposed upstream of the temperature sensor 325 in the rotation direction of the lower belt 40.

Note that, in the above-described temperature sensor selection process, Temp3 is a value obtained by adding the temperatures detected by the temperature sensor 310 and the temperature sensor 320, and Temp4 is a value obtained by adding the temperatures detected by the temperature sensor 315 and the temperature sensor 325. However, Temp3 and Temp4 are not limited thereto, and Temp3 may be a temperature detected by the temperature sensor 310 or the temperature sensor 320, and Temp4 may be a temperature detected by the temperature sensor 315 or the temperature sensor 325.

In this case, it is determined in step S306 whether ΔTemp2 is larger than 3. When ΔTemp2 is larger than 3, the process proceeds to step S310. When ΔTemp2 is equal to or less than 3, the process proceeds to step S307. In the processing of step S310, it is determined whether ΔTemp2 is larger than 3 three times in succession.

In the present embodiment, the CPU 1100 performs temperature adjustment control based on a higher one of the temperature detected by the temperature sensor 310 and the temperature sensor 320 and the temperature detected by the temperature sensor 315 and the temperature sensor 325. In this manner, in the present embodiment, it is also possible to perform temperature adjustment control using the temperature sensor 315 inside the upper belt 30 and the temperature sensor 325 inside the lower belt 40.

As a result, in addition to the effects of the first embodiment described above, a temperature of the upper belt 30 can be stably detected by making the shape of the upper belt 30 and the surface of the upper belt 30 less affected by adhesion of dirt. In addition, a temperature of the lower belt 40 can be stably detected by making the shape of the lower belt 40 and the surface of the lower belt 40 less affected by adhesion of dirt.

It goes without saying that the present disclosure is not limited to the above-described embodiments, and various modifications can be made without departing from the spirit of the present disclosure.

Specifically, in the first and second embodiments described above, the temperature sensor 325, the temperature sensor 326, and the temperature sensor 327 are provided inside the lower belt 40, but are not limited thereto. The temperature sensor 325, the temperature sensor 326, and the temperature sensor 327 may not be provided. Even if the temperature sensor 325, the temperature sensor 326, and the temperature sensor 327 are not provided, it is possible to accurately perform temperature adjustment control of the upper belt 30 abutting on the image forming surface of the sheet S using the temperature sensor 315, the temperature sensor 316, and the temperature sensor 317.

In the first and second embodiments described above, the heating portion 117, the heating portion 127, and the heating portion 137 are provided inside the upper belt 30, and the heating portion 147 and the heating portion 157 are provided inside the lower belt 40. However, the heating portion 117, the heating portion 127, the heating portion 137, the heating portion 147, and the heating portion 157 are not limited thereto, and may be provided outside the upper belt 30 and the lower belt 40.

According to the present disclosure, it is possible to accurately detect temperature changes of the upper belt and the lower belt when the upper belt and the lower belt are directly heated and maintained at a predetermined temperature.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-210080, filed Dec. 3, 2024, which is hereby incorporated by reference herein in its entirety.

What is claimed is:

1. A fixing device that heats and pressurizes a sheet to fix an image onto the sheet, the fixing device comprising:
an endless upper belt;
an endless lower belt configured to nip and convey the sheet together with the upper belt in a nip portion formed by abutting on the upper belt;
a plurality of heating portions configured to heat the upper belt and the lower belt;
a first temperature sensor disposed outside the upper belt, and configured to detect a temperature of the upper belt in a non-contact manner in a region where the upper belt ascends from an outlet of the nip portion; and
a second temperature sensor configured to detect a temperature in a non-contact manner in a region other than the nip portion downstream of the first temperature sensor in a conveyance direction of the upper belt,
wherein an error is reported when a difference between the temperature detected by the first temperature sensor and the temperature detected by the second temperature sensor is equal to or more than a predetermined value.

2. The fixing device according to claim 1, wherein
the second temperature sensor is disposed inside the upper belt.

3. The fixing device according to claim 1, further comprising:
a controller configured to perform temperature adjustment control for maintaining temperatures of the upper belt and the lower belt at a predetermined temperature by controlling the plurality of heating portions based on the temperatures detected by the first temperature sensor and the second temperature sensor.

4. The fixing device according to claim 1, wherein
the second temperature sensor is disposed inside the upper belt and inside the lower belt.

5. The fixing device according to claim 1, wherein
the first temperature sensor is provided at a plurality of locations in a width direction orthogonal to the conveyance direction of the sheet,
the second temperature sensor is provided at a plurality of locations that is the same in the width direction as the plurality of locations where the first temperature sensor is provided, and
an error is reported when a difference between temperatures detected by the first temperature sensor and the second temperature sensor provided at the same position in the width direction is equal to or more than the predetermined value.

6. The fixing device according to claim 1, wherein
the plurality of heating portions heats an inner surface of the upper belt and an inner surface of the lower belt.

7. The fixing device according to claim 1, wherein
each of the plurality of heating portions includes a halogen heater.

8. The fixing device according to claim 1, wherein
the first temperature sensor and the second temperature sensor are infrared sensors configured to detect temperatures using infrared rays.

9. An image forming apparatus comprising:
the fixing device according to claim 1;
an image forming portion configured to form an image on a sheet with ink; and
a drying portion configured to dry the image formed on the sheet by the image forming portion,
wherein the fixing device heats and pressurizes the image dried by the drying portion to fix the image onto the sheet.

10. A fixing device that heats and pressurizes a sheet to fix an image onto the sheet, the fixing device comprising:
an endless upper belt;
an endless lower belt configured to nip and convey the sheet together with the upper belt in a nip portion formed by abutting on the upper belt;
a plurality of heating portions configured to heat the upper belt and the lower belt;
a first temperature sensor disposed outside each of the upper belt and the lower belt, and configured to detect a temperature of each of the upper belt and the lower belt in a non-contact manner from an outlet of the nip portion to a point parallel to the nip portion of each of the upper belt and the lower belt; and
a second temperature sensor configured to detect a temperature in a non-contact manner in a region other than the nip portion downstream of the first temperature sensor in a conveyance direction of the upper belt,
wherein temperature adjustment control is performed for maintaining temperatures of the upper belt and the lower belt at a predetermined temperature by controlling the plurality of heating portions based on the temperatures detected by the first temperature sensor and the second temperature sensor.

11. The fixing device according to claim 10, wherein
the second temperature sensor is disposed inside the upper belt.

12. The fixing device according to claim 10, wherein
the second temperature sensor is disposed inside the upper belt and inside the lower belt.

13. The fixing device according to claim 10, wherein
the plurality of heating portions heats an inner surface of the upper belt and an inner surface of the lower belt.

14. The fixing device according to claim 10, wherein
each of the plurality of heating portions includes a halogen heater.

15. The fixing device according to claim 10, wherein
the first temperature sensor and the second temperature sensor are infrared sensors configured to detect temperatures using infrared rays.

16. An image forming apparatus comprising:
the fixing device according to claim 10;
an image forming portion configured to form an image on a sheet with ink; and
a drying portion configured to dry the image formed on the sheet by the image forming portion,
wherein the fixing device heats and pressurizes the image dried by the drying portion to fix the image onto the sheet.

17. A fixing device that heats and pressurizes a sheet to fix an image onto the sheet, the fixing device comprising:
an endless upper belt;
an endless lower belt configured to nip and convey the sheet together with the upper belt in a nip portion formed by abutting on the upper belt;
a plurality of heating portions configured to heat the upper belt and the lower belt;
a first temperature sensor disposed outside the upper belt and the lower belt, and configured to detect a temperature of each of the upper belt and the lower belt in a non-contact manner in a region where the belt ascends from an outlet of the nip portion; and
a second temperature sensor configured to detect a temperature in a non-contact manner in a region other than the nip portion downstream of the first temperature sensor in a conveyance direction of the upper belt.
